(19) United States
(12) Patent Application Publication
(10) Pub. No.: US 2017/0023843 A1
(43) Pub. Date: Jan. 26, 2017

(54) APPARATUS FOR BEAM-DIVIDING USING ACOUSTO-OPTIC MODULATORS

(71) Applicant: Coherent Kaiserslautern GmbH, Kaiserslautern (DE)

(72) Inventor: Albert SEIFERT, Kaiserslautern (DE)

(21) Appl. No.: 14/803,460

(22) Filed: Jul. 20, 2015

(51) Int. Cl. G02F 1/33; G02F 1/37; G02F 1/355

(52) U.S. Cl. CPC G02F 1/33; G02F 1/3551; G02F 1/37

(57) ABSTRACT

An apparatus for temporally dividing pulses from a train of optical pulses into angularly-separated beam paths is disclosed. The apparatus includes no more than one acousto-optic modulator (AOM) for each beam path. The AOMs are configured and arranged to maximize the angular separation of the beam paths and to maximize the energy of each divided pulse. Pulses on the separated beam paths have equal pulse energies and may be gated independently.

### TECHNICAL FIELD OF THE INVENTION

The present invention relates in general to acousto-optic modulators in trains of laser-radiation pulses. The invention relates in particular to the temporal division of radiation pulses into angularly-separated beam paths.

### DISCUSSION OF BACKGROUND ART

Acousto-optic modulators (AOMs) are used extensively in the photonics industry for manipulating beams of radiation. An AOM comprises a piezo-electric transducer (PZT) bonded to an interaction medium. An oscillating electric-potential in the radio-frequency (RF) range is applied to the transducer, generating an acoustic wave that propagates through the interaction medium. The acoustic wave produces a periodic modulation in optical refractive-index, in effect, a refractive-index grating. An incident optical-beam is diffracted by the refractive-index grating, creating a diffracted optical-beam that diverges from the incident beam. With no oscillating-potential, the incident-beam is transmitted through the interaction medium with losses due to absorption, reflection, and scattering.

The angle-of-incidence of the incident optical-beam is selected to maximize the fraction of the incident optical power diffracted into a target order of the refractive-index grating. Modulating the amplitude of the oscillating-potential modulates the amplitude of the diffracted-beam. Modulating the frequency of the oscillating-potential modulates the angle-of-diffraction.

There are many applications that use an AOM to select pulses from a train of laser-radiation pulses. By way of example, an AOM can be used to select specific pulses from a laser oscillator or pre-amplifier for further amplification. By way of another example, an AOM can be used to select specific pulses from a train of mode-locked pulses for temporal compression. A plurality of AOMs can be used to divide pulses between a plurality of amplifiers and compressors.

AOMs diffract into the first-order with highest efficiency. An AOM can be characterized by a diffraction efficiency, which is the ratio of pulse energy in the first-order diffracted-beam to pulse energy in the un-diffracted-beam. AOMs have typical diffraction efficiencies of less than 90%.

Although one AOM can divide pulses between a diffracted-beam and an un-diffracted-beam; pulses in the diffracted- and un-diffracted-beams will have different energies. One AOM can divide pulses between two diffracted-beams by modulating the oscillating-potential between two frequencies. However, for the diffracted-beams to have a practical angular separation and equal pulse energies, a compromise angle-of-incidence is necessary, having substantially reduced diffraction efficiency.

Prior-art beam-dividing schemes divide pulses equally by including optical beam-splitters to create angularly-separated beam paths, having identical trains of radiation pulses, with an AOM in each beam path to select specific pulses. Polarizing beam-splitting cubes and thin-film partially-reflective mirrors are examples of beam-splitters. Beam-splitters also divide the pulse energy. Each such divided and selected pulse has just a fraction of the energy of the incident pulse.

Other prior-art schemes divide pulses equally by including one or more pulse-pickers to create angularly-separated beam paths, having pulses at a reduced duty-cycle or reduced repetition-rate, with an AOM in each separated beam path to select specific pulses. AOMs and electro-optic modulators (EOMs) are examples of pulse-pickers. AOMs are typically less expensive than EOMs. The AOMs on separate beam paths may be configured to select pulses at reduced efficiencies, as required, to divide pulses equally. Such schemes require complex apparatus, having more than one modulator in each beam path, and the energy of each selected pulse is attenuated by the cumulative losses of the modulators.

There is need for less-complex apparatus for dividing pulses from an optical-beam along angularly-separated beam paths, with equal losses for all beam paths. Preferably, the apparatus would allow one laser to service multiple applications, with each application operating independently and each application having access to most of the pulse energy of laser.

### SUMMARY OF THE INVENTION

In one aspect, optical apparatus in accordance with the present invention comprises a source of pulsed laser-radiation arranged to deliver a train of laser-radiation pulses. First and second acousto-optic modulators (AOMs) are arranged in series to intercept the train of laser-radiation pulses. The first and second AOMs are connected to respectively first and second radio-frequency generators (RFGs). Each RFG supplies radio-frequency (RF) power to the corresponding AOM. Operation of the first and second RFGs is regulated by respectively first and second control-signals, such that the RF power is at exclusively a high value or a low value. The first and second AOMs diffract pulses from the train of laser-radiation pulses along respectively first and second optical paths when the corresponding RF power is at the high value. The first and second optical paths are at an angle to each other. The control-signals are regulated such that when RF power is supplied to one of the AOMs at the high value, RF power is supplied to the other AOM at the low value.

### BRIEF DESCRIPTION OF THE DRAWINGS

The accompanying drawings, which are incorporated in and constitute a part of the specification, schematically illustrate a preferred embodiment of the present invention, and together with the general description given above and the detailed description of the preferred embodiment given below, serve to explain principles of the present invention.

FIG. 1 is a block diagram schematically illustrating one preferred embodiment of apparatus in accordance with the present invention including a laser source for delivering a train of laser-radiation pulses, two acousto-optic modulators (AOMs) located in the train of radiation pulses for creating two diffracted optical paths, a residual un-diffracted-beam that is transmitted through the AOMs, two radio-frequency (RF) generators to supply RF power to the AOMs, and two control-signals that set the RF powers.

FIG. 2A, FIG. 2B, FIG. 2C, FIG. 2D, and FIG. 2E form a timing diagram schematically illustrating a scheme for arbitrarily dividing pulses temporally and angularly exclusively into the two diffracted optical paths in the apparatus of FIG. 1.

FIG. 3A, FIG. 3B, FIG. 3C, FIG. 3D, and FIG. 3E form a timing diagram schematically illustrating another scheme for independently dividing pulses temporally and angularly exclusively into the two diffracted optical paths in the apparatus of FIG. 1.

FIG. 4 schematically illustrates another preferred embodiment of apparatus in accordance with the present invention, similar to the embodiment of FIG. 1, but wherein two gate-signals and two logic-elements set the RF powers during radiation pulses.

FIG. 5A, FIG. 5B, FIG. 5C, FIG. 5D, FIG. 5E, FIG. 5F, and FIG. 5G form a timing diagram schematically illustrating a scheme for independently dividing pulses temporarily and angularly exclusively into the two diffracted optical paths in the apparatus of FIG. 4.

FIG. 6 schematically illustrates yet another preferred embodiment of apparatus in accordance with the present invention, similar to the embodiment of FIG. 1, but wherein two optically nonlinear crystals generate second-harmonic pulses from radiation pulses on the two diffracted optical paths.

FIG. 7 schematically illustrates still another preferred embodiment of apparatus in accordance with the present invention, similar to the embodiment of FIG. 1, but wherein two additional AOMs located in the train of radiation pulses create two additional diffracted optical paths.

### DETAILED DESCRIPTION OF THE INVENTION

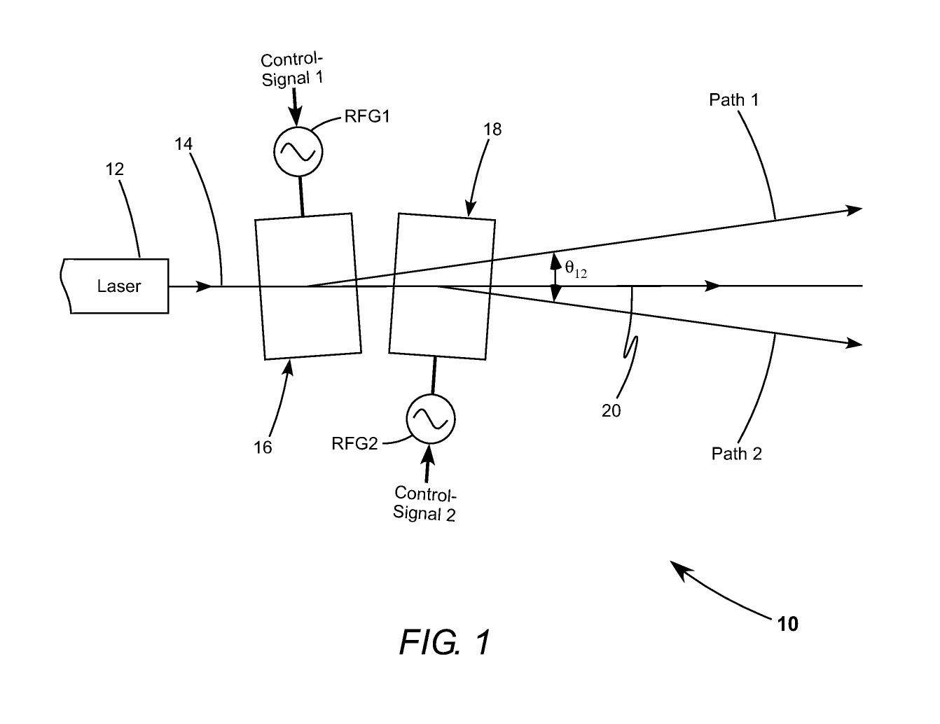

Referring now to the drawings, wherein like components are designated by like reference numerals, FIG. 1 schematically illustrates, in block diagram form, one preferred embodiment 10 of apparatus in accordance with the present invention. Apparatus 10 includes a source of laser-radiation 12 that delivers a train of laser-radiation pulses 14.

Apparatus 10 includes a first acousto-optic modulator (AOM) 16 and a second-AOM 18, arranged in series, and located in the train of radiation pulses. A pulse of laser radiation is diffracted when radio-frequency (RF) power is applied to an AOM. The pulse is diffracted into a first optical path (path 1) when RF power is applied only to AOM 16. The pulse is diffracted into a second optical path (path 2) when RF power is applied only to AOM 18. Path 1 and path 2 are separated by an angle θ₁₂. When no RF power is applied to both AOMs, there is no diffraction, and the pulse is refracted through the AOMs along an un-diffracted optical path 20.

Apparatus 10 includes a first radio-frequency generator (RFG) RFG1 and a second radio-frequency generator RFG2 that are sources of RF power for the corresponding AOM. RF power applied to the first AOM is regulated by a first control-signal, control-signal 1. RF power applied to the second AOM is regulated by a second control-signal, control-signal 2. The control-signals set the RF power generated by the corresponding RFG to exclusively a high value or a low value. Preferably, the AOM are arranged and configured such that diffraction efficiency is optimized when RF power at the high value is applied to an AOM. Preferably, the low value of RF power is near or equal to zero.

In the representation of FIG. 1, apparatus 10 is configured and arranged such that each AOM operates in the −1 diffraction-order, which yields the highest diffraction efficiency, as is known in the art. With the AOMs operating in the same diffraction-order and with the same RF power, pulses are diffracted into paths 1 and 2 with approximately the same diffraction efficiency. The energies of pulses diffracted into paths 1 and 2 are therefore approximately the same. Further, AOMs 16 and 18 are arranged such that paths 1 and 2 diverge from the un-diffracted path 20 in opposite angular directions, to maximize the angle θ₁₂.

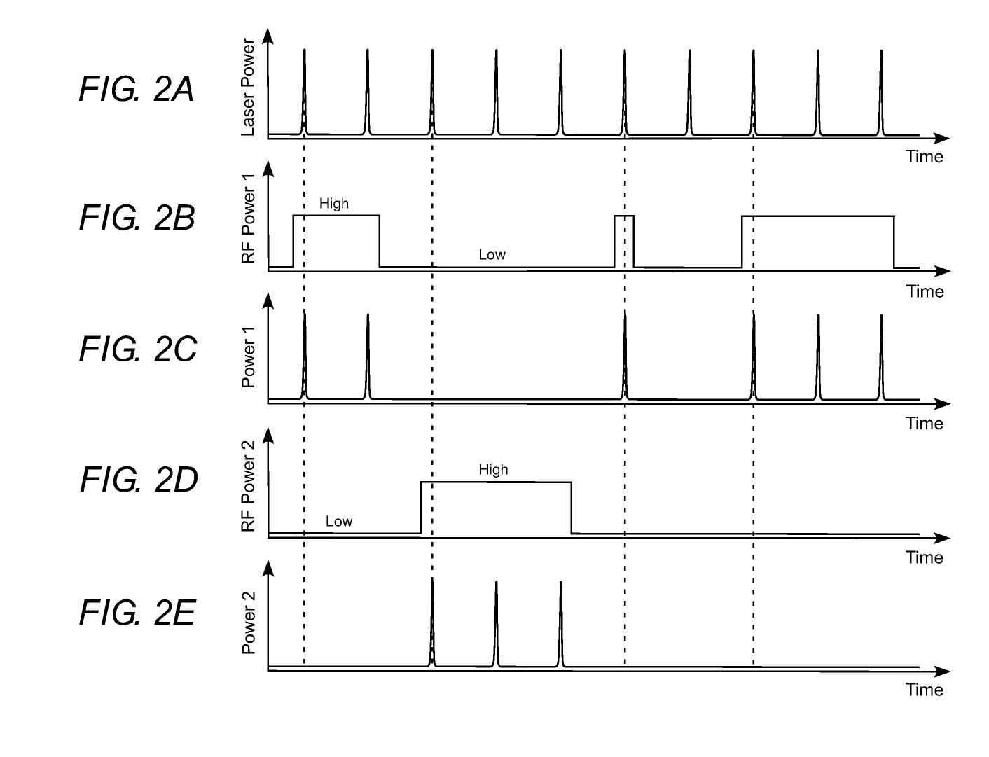

FIG. 2A, FIG. 2B, FIG. 2C, FIG. 2D, and FIG. 2E form a timing diagram schematically illustrating a scheme for dividing pulses temporally and angularly into the first and second optical paths in the apparatus of FIG. 1. FIG. 2A depicts optical power in the train of radiation pulses as a function of time. FIG. 2B depicts RF power applied to the first AOM as a function of time. FIG. 2C depicts optical power along path 1 as a function of time. FIG. 2D depicts RF power applied to the second AOM as a function of time. FIG. 2E depicts optical power along path 2 as a function of time. RF power in FIG. 2B and FIG. 2D is set at the high and low values by the corresponding control-signal. The control-signals are regulated such that when RF power is supplied to one of the AOMs at the high value, RF power is supplied to the other AOM at the low value. Pulses are thereby divided from the un-diffracted path exclusively along one of path 1 and path 2, as required. Pulses may also be discarded by setting the RF power supplied to both AOMs to the low value and allowing them to propagate along the un-diffracted path.

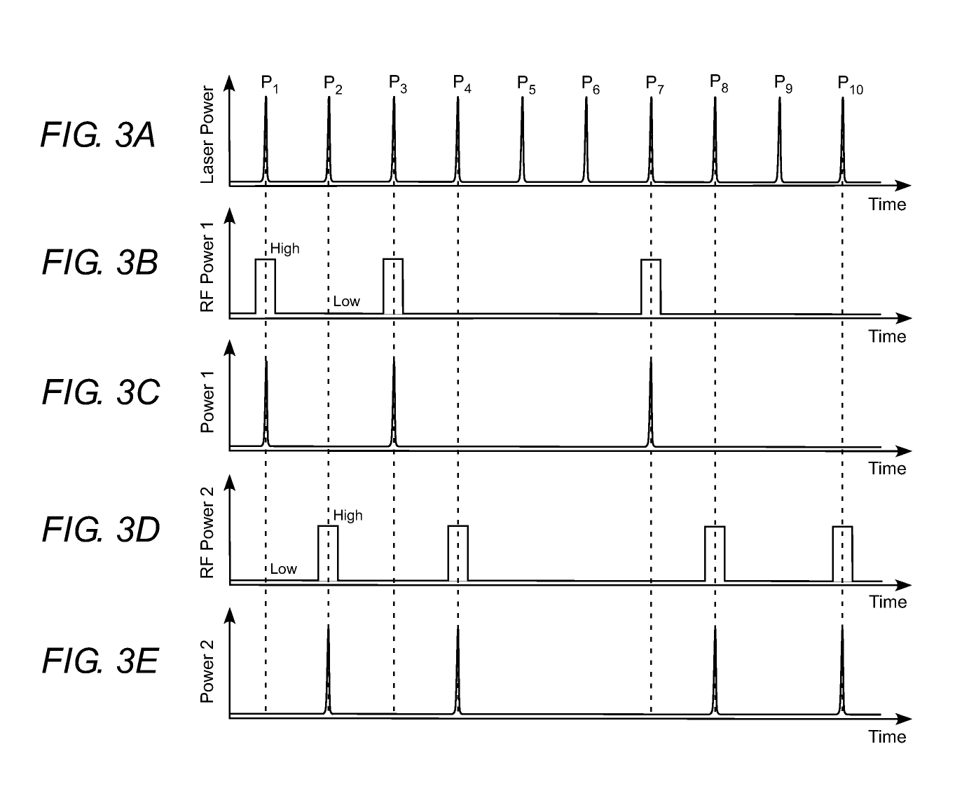

FIG. 3A, FIG. 3B, FIG. 3C, FIG. 3D, and FIG. 3E form a timing diagram schematically illustrating another scheme for dividing pulses temporally and angularly into the first and second optical paths. FIG. 3A depicts optical power in the train of radiation pulses as a function of time. For purposes of this description and the appended claims, each pulse in the train is labeled arbitrarily by an integer in consecutive numerical order. FIG. 3B depicts RF power applied to the first AOM as a function of time. FIG. 3C depicts optical power along path 1 as a function of time. FIG. 3D depicts RF power applied to the second AOM as a function of time. FIG. 3E depicts optical power along path 2 as a function of time. The control-signals are further regulated such that RF power is only supplied to the first AOM during odd-numbered pulses, and RF power is only supplied to the second AOM during even-numbered pulses. Pulses may thereby be divided into path 1 and path 2, independently, and as required.

Selecting consecutive odd-numbered pulses creates a train of optical pulses on path 1 with half the repetition rate of the original train of radiation pulses. Similarly, selecting consecutive even-numbered pulses creates a train of optical pulses on path 2 with half the repetition rate of the original train of laser-radiation pulses. The scheme of FIGS. 3A-E therefore provides two trains of optical pulses that can be switched on and off independently, and as required.

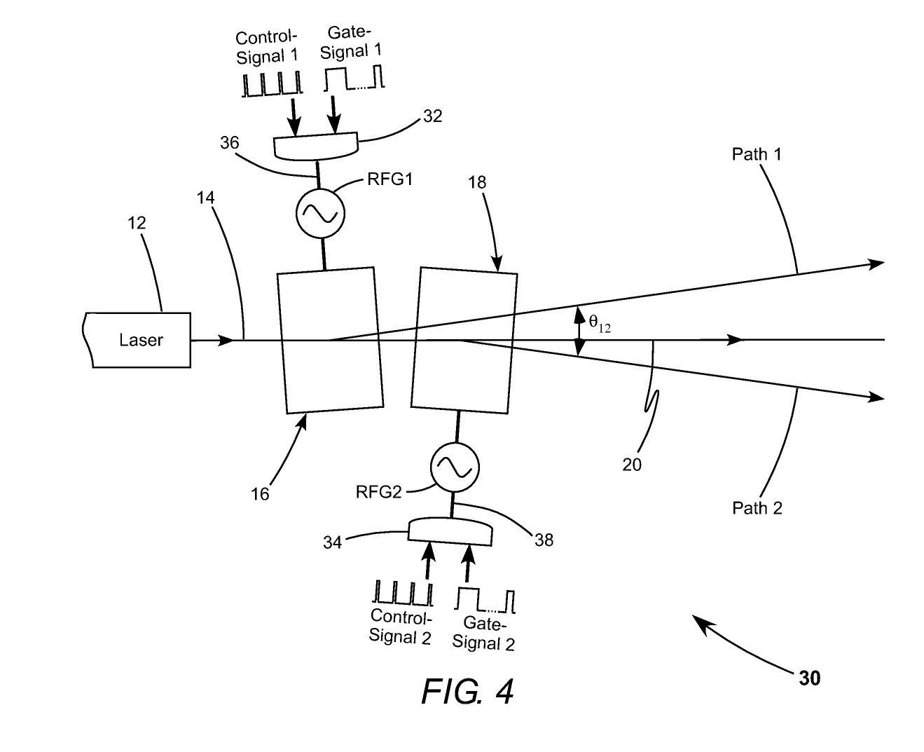

FIG. 4 schematically illustrates another preferred embodiment 30 of beam dividing apparatus in accordance with the present invention. Apparatus 30 is similar to apparatus 10 of FIG. 1, with an addition of a first gate-signal (gate-signal 1) and a second gate-signal (gate-signal 2) for operating respectively AOM 16 and AOM 18. Each gate-signal is at exclusively an enable value or a disable value. Apparatus 30 further includes a first logic-element 32 connected to RFG1 through connection 36 and a second logic-element 34 connected to RFG2 through connection 38. Each logic-element processes the control-signal and the gate-signal to set the RF power applied to the corresponding AOM. Electronic circuits, logic gates, and programmable logic devices are examples of such logic-elements.

In the arrangement of FIG. 4, each control-signal is a continuous train of pulses at half the repetition rate of the original train of radiation pulses. Control-signal 1 is at a high value during every odd-numbered pulse and is otherwise at a low value. Control-signal 2 is at a high value during every even-numbered pulse and is otherwise at a low value.

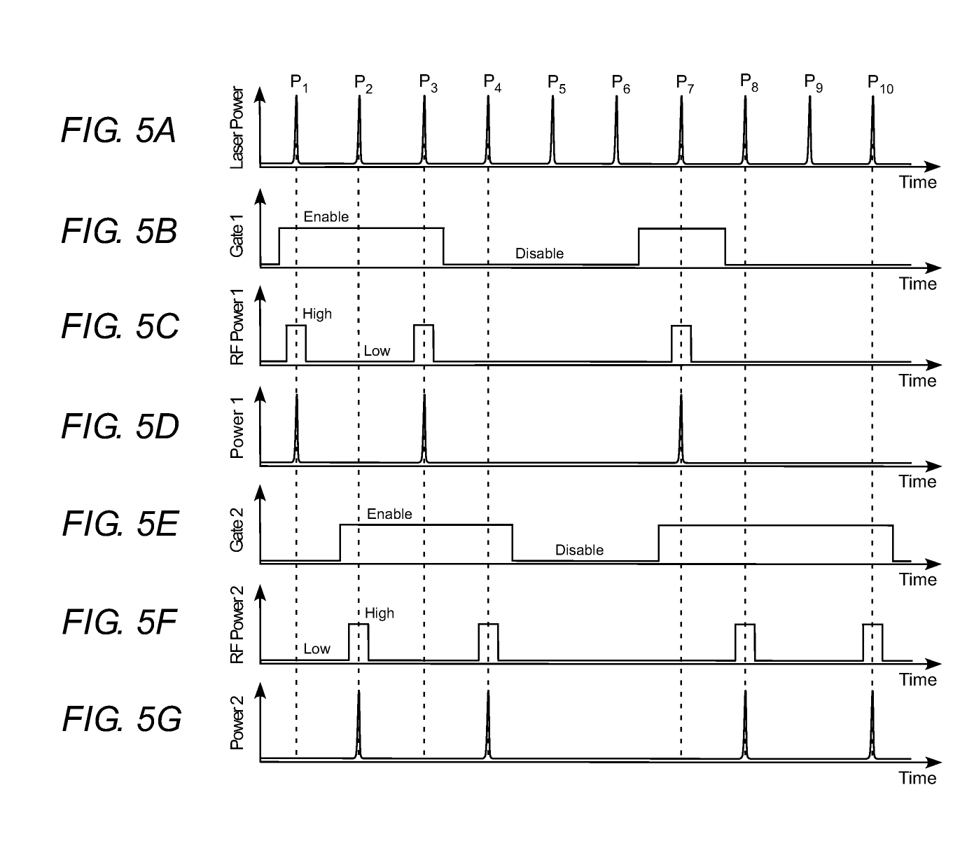

FIG. 5A, FIG. 5B, FIG. 5C, FIG. 5D, FIG. 5E, FIG. 5F, and FIG. 5G form a timing diagram schematically illustrating a scheme for dividing pulses temporarily and angularly into the first and second optical paths in the apparatus of FIG. 4. FIG. 5A depicts optical power in the train of radiation pulses as a function of time. Here again, for purposes of this description and the appended claims, each pulse in the train is labeled arbitrarily by an integer in consecutive numerical order. FIG. 5B depicts the value of the gate-signal 1 as a function of time. FIG. 5C depicts RF power applied to the first AOM as a function of time. FIG. 5D depicts optical power along path 1 as a function of time. FIG. 5E depicts the value of gate-signal 2 as a function of time. FIG. 5F depicts the RF power applied to the second AOM as a function of time. FIG. 5G depicts optical power along path 2 as a function of time. When control-signal 1 is at the high value and gate-signal 1 is at the enable value, RF power at the high value is applied to the first AOM. When control-signal 2 is at the high value and gate-signal 2 is at the enable value, RF power at the high value is applied to the second AOM. For all other conditions of the control-signal and gate-signal, RF power at the low value is applied to the corresponding AOM.

The scheme of FIGS. 5A-G provides two trains of optical pulses, at half the repetition rate of the original train of optical pulses, which can be gated on and off independently as required. By way of example, in laser material processing, the scheme enables one laser source to service two work stations. A work station on path 1 can gate pulses on and off as required by an application, independently of another work station on path 2, which can gate pulses on and off as required by another application. No coordination is necessary between the two work stations to divide pulses from the original train of laser-radiation pulses.

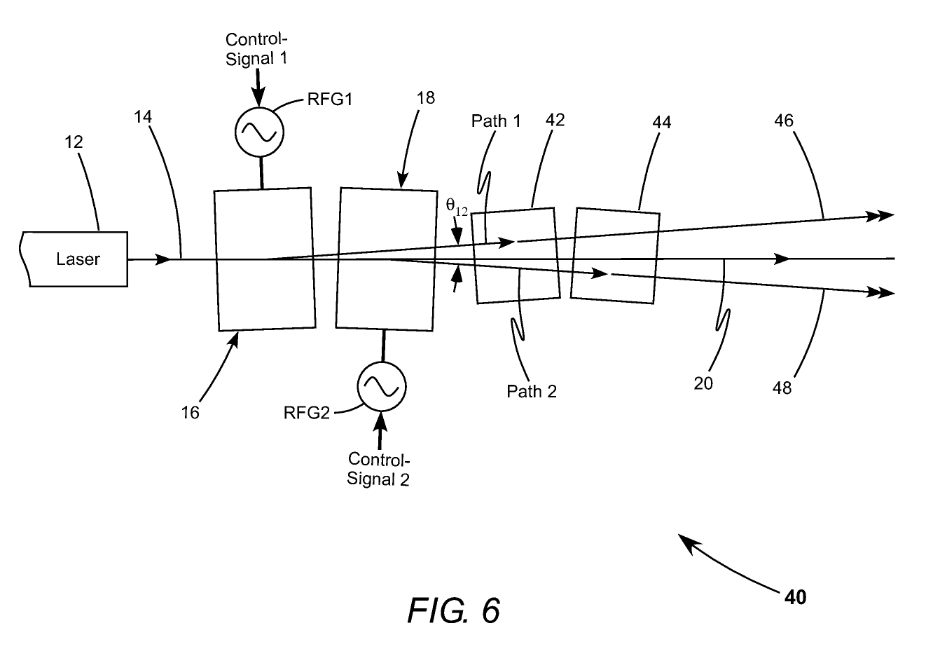

FIG. 6 schematically illustrates yet another preferred embodiment 40 of beam-dividing apparatus in accordance with the present invention. Apparatus 40 is similar to apparatus 10 of FIG. 1, with an addition of a first optically nonlinear crystal 42 and a second optically nonlinear crystal 44. The optically nonlinear crystals are arranged to intercept path 1 and path 2. Crystal 42 is configured and arranged to generate second-harmonic pulses 46 from the pulses on path 1. Crystal 44 is configured and arranged to generate second-harmonic pulses 48 from the pulses on path 2. One of the crystals may be omitted if the application requires one fundamental train of pulses, and one second-harmonic train of pulses.

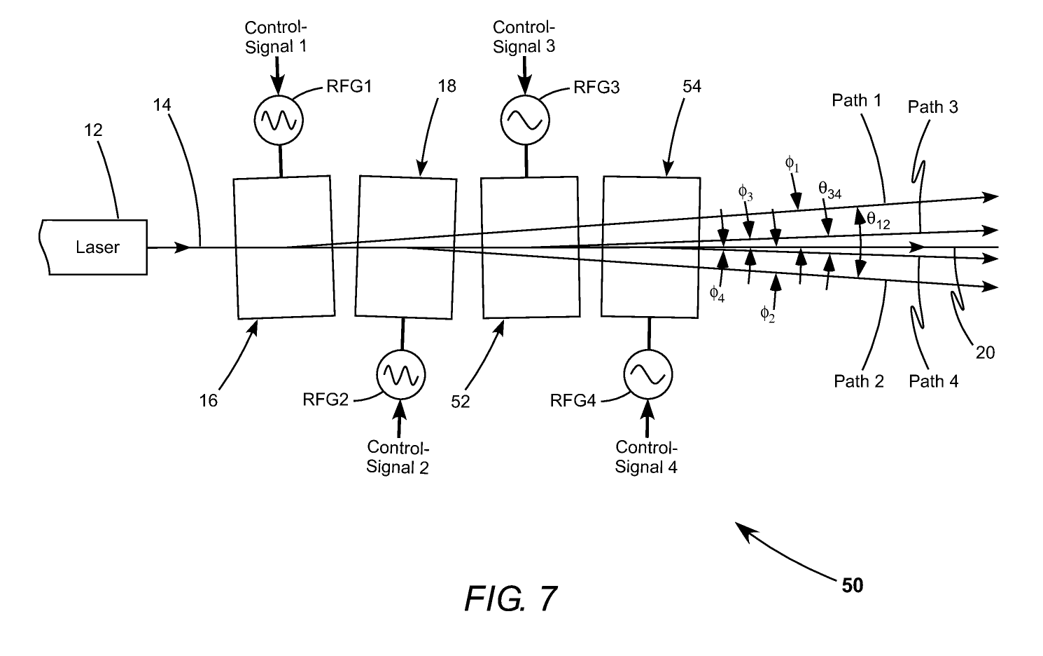

From the description provided above, those skilled in the art would recognize that it is possible to add one or more AOMs to apparatus 10 to create additional optical paths. By way of example, FIG. 7 schematically illustrates still another preferred embodiment 50 in accordance with the present invention. Apparatus 50 is similar to apparatus 10 of FIG. 1 with an addition of a third AOM 52 and a fourth AOM 54 arranged in series after AOM 16 and AOM 18. All four AOMs are located in the train of radiation pulses. A third RFG (RFG3) and a fourth RFG (RFG4) are sources of RF power for AOMs 52 and 54, respectively. RF power applied to the third AOM is regulated by a third control-signal (control-signal 3). RF power applied to the fourth AOM is regulated by a fourth control-signal (control-signal 4). A pulse is diffracted into a third optical path (path 3) when RF power at the high value is applied only to AOM 52. The pulse is diffracted into a fourth optical path (path 4) when RF power at the high value is applied only to AOM 54. Path 3 and path 4 are separated by an angle θ₃₄.

In the representation of FIG. 7, the AOMs are configured and arranged such that each AOM operates in the −1 diffraction-order. Further, the AOMs are arranged such that path 1 and path 3 diverge from un-diffracted path 20 in opposite angular directions to path 2 and path 4. Here, angles φ₁ and φ₂ between respectively the first and second optical paths and un-diffracted path 20 are larger than angles φ₃ and φ₄ between respectively the third and fourth optical paths and un-diffracted path 20. Larger diffraction angles are created by supplying RF power to an AOM at higher RF frequencies, as is known in the art. This arrangement maximizes the angular separation between all the diffracted optical paths at all locations along the optical paths.

The control-signals are regulated such that when RF power is supplied to one of the AOMs at the high value, RF power is supplied to all other AOMs at the low value. Pulses are thereby divided from the un-diffracted path along one of the four optical paths, as required.

In summary, a train of radiation pulses can be temporally divided between angularly-separated optical paths with an apparatus having one AOM for each optical path and no passive beam splitters. The AOM can be arranged such that pulses on all optical paths have approximately the same energy. The embodiments described above indicate that by regulating the RF power applied to the AOMs, each optical path can supply pulses to a distinct application. Pulses on each optical path may be gated on and off as required by the application, and independently from the other applications.

The present invention is described above in terms of a preferred embodiment and other embodiments. The invention is not limited, however, to the embodiments described and depicted herein. Rather, the invention is limited only by the claims appended hereto.

What is claimed is:

1. Optical apparatus, comprising:
a source of pulsed laser-radiation arranged to deliver a train of laser-radiation pulses;
first and second acousto-optic modulators (AOMs) arranged in series to intercept the train of radiation pulses, the first and second AOMs connected to respectively first and second radio-frequency generators (RFGs), each RFG supplying radio-frequency (RF) power to the corresponding AOM, operation of the first and second RFGs regulated by respectively first and second control-signals such that the RF power is at exclusively a high value or a low value, the first and second AOMs diffracting pulses from the train thereof along respectively first and second optical paths when the corresponding RF power is at the high value, the first and second optical paths being at an angle to each other; and
wherein the control-signals are regulated such that when RF power is supplied to one of the AOMs at the high value, RF power is supplied to the other AOM at the low value.

2. The apparatus as recited in claim 1, wherein the low value of RF power supplied to any of the AOMs is zero.

3. The apparatus as recited in claim 1, wherein the AOMs are arranged such that the first and second optical paths diverge from the original train of radiation pulses in opposite angular directions.

4. The apparatus as recited in claim 1, wherein the control-signals are regulated such that RF power is only supplied to the first AOM at the high value during odd-numbered radiation pulses and RF power is only supplied to the second AOM at the high value during even-numbered radiation pulses, the radiation pulses numbered arbitrarily by integers in consecutive numerical order.

5. The apparatus as recited in claim 4, wherein operation of the first and second RFGs is further regulated by respectively first and second gate-signals, each gate-signal is exclusively at an enable value or a disable value, the first and second AOMs are supplied with RF power at the high value only when the corresponding gate-signal is at the enable value.

6. The apparatus as recited in claim 1, wherein first and second optically nonlinear crystals are arranged to intercept respectively the first and second optical paths, each optically nonlinear crystal being configured and arranged to generate second-harmonic pulses from the corresponding diffracted pulses.

7. The apparatus as recited in claim 1, further including third and fourth AOMs arranged in series to intercept the train of radiation pulses, the third and fourth AOMs connected to respectively third and fourth RFGs, each RFG for supplying RF power to the corresponding AOM, operation of the third and fourth RFGs being regulated by respectively third and fourth control-signals such that the RF power is at exclusively a high value or a low value, the third and fourth AOMs diffracting pulses from the train thereof along respectively third and fourth optical paths when the corresponding RF power is at the high value, the third and fourth optical paths being at an angle to each other, and at angles to each of the first and second optical paths, and wherein the first, second, third, and fourth control-signals are regulated such that when RF power is supplied to one of the AOMs at the high value, RF power is supplied to all of the other AOMs at the low value.

8. Optical apparatus, comprising:
first and second acousto-optic modulators (AOMs) arranged in series to intercept a train of radiation pulses, the first AOM diffracting pulses into a first optical path when it is on, the second AOM diffracting pulses into a second optical path when it is on, the first and second optical paths being at an angle to each other, pulses continuing along an un-diffracted optical path when both AOMs are off; and
wherein the AOMs are regulated such that when one AOM is on, the other AOM is off.

9. The apparatus as recited in claim 8, wherein the AOMs are arranged such that the first and second optical paths diverge from the original train of radiation pulses in opposite angular directions.

10. The apparatus as recited in claim 8, wherein operation of the first and second AOMs is further regulated by respectively first and second gate-signals, each gate signal is exclusively at an enable value or a disable value, the first and second AOMs are turned on only when the corresponding gate-signal is at the enable value.

11. A method for selectively directing pulses from a train of radiation pulses along one of a first, second and third optical paths using first and second acousto-optic modulators (AOMs) arranged in series to intercept the train of radiation pulses, said method comprising:
turning on only the first AOM when it is desired to direct the pulses along the first optical path;
turning on only the second AOM when it is desired to direct the pulses along the second optical path; and
turning off both AOMs when it is desired to direct the pulses along the third optical path.

12. The method as recited in claim 11, wherein the AOMs are arranged such that the first and second optical paths diverge from the third path in opposite angular directions.

13. The method as recited in claim 11, wherein the AOMs are regulated such that the first AOM is only on during odd-numbered radiation pulses and the second AOM is only on during even-numbered radiation pulses, the radiation pulses numbered arbitrarily by integers in consecutive numerical order.

14. The method as recited in claim 13, wherein operation of the first and second AOMs is further regulated by respectively first and second gate-signals, each gate-signal is exclusively at an enable value or a disable value, the first and second AOMs are on only when the corresponding gate-signal is at the enable value.

15. The method as recited in claim 11, wherein first and second optically nonlinear crystals are arranged to intercept respectively the first and second optical paths, each optically nonlinear crystal being configured and arranged to generate second-harmonic pulses from the corresponding diffracted pulses.

16. The method as recited in claim 11, further including third and fourth AOMs arranged in series to intercept the train of radiation pulses, the third and fourth AOMs diffracting pulses from the train of radiation pulses along respectively third and fourth optical paths when the respective AOM is on, the third and fourth optical paths being at an angle to each other, the third and fourth optical paths being at angles to each of the first and second optical paths, radiation pulses continuing along an un-diffracted beam path when all AOMs are off, and wherein the AOMs are regulated such that when one AOM is on, all the other AOMs are off.
